(19) United States
(12) Patent Application Publication
(10) Pub. No.: US 2003/0227420 A1
(43) Pub. Date: Dec. 11, 2003

(54) INTEGRATED APERTURE AND CALIBRATION FEED FOR ADAPTIVE BEAMFORMING SYSTEMS

(75) Inventors: Joel C. Roper, Plano, TX (US); Michael D. Thomas, Richardson, TX (US)

Correspondence Address: WOOD, HERRON & EVANS, LLP, 2700 CAREW TOWER, 441 VINE STREET, CINCINNATI, OH, 45202, US

(73) Assignee: Andrew Corporation, Orland Park, IL

(21) Appl. No.: 10/163,186

(22) Filed: Jun. 5, 2002

(51) Int. Cl. H01Q 21/26

(52) U.S. Cl. 343/797; 343/700 MS

(57) ABSTRACT

An antenna includes a substrate to which a plurality of dual polarized radiators, each including first and second radiators, are coupled and arranged into a plurality of rows and columns. The substrate has a stripline distribution network coupled to the plurality of dual polarized radiators, with the stripline distribution network including first and second corporate feed networks coupled to a first column of dual polarized radiators among the plurality of columns. The first corporate feed network is coupled to the first radiating elements of the dual polarized radiators in the first column and extends along a first side of the first column, and the second corporate feed network is coupled to the second radiating elements of the dual polarized radiators in the first column and extends generally along a second side of the first column. The substrate has a stripline calibration feed network coupled to the first and second corporate feed networks. The stripline calibration feed network includes a calibration feed trace that extends along the first column of dual polarized radiators intermediate the first and second corporate feed networks.

### FIELD OF THE INVENTION

This invention relates generally to beam forming antennas, and more particularly to calibration of such antennas.

### BACKGROUND OF THE INVENTION

Many antennas used for cellular communications today are constructed by mounting multiple radiating elements in vertical columns. The width of the total aperture determines the width of the beam formed by the antenna. The spacing between the columns determines the antenna's ability to be scanned, e.g. the ability to point the beam of the antenna.

The beam of these antennas is controlled by varying the amplitude and phase of the signals feeding the columns. A system that varies the amplitude/phase signal to each of the columns is often referred to as an “adaptive beamformer.”

In certain applications, individual amplifiers are used to power each of the columns in an antenna. These amplifiers often vary in response, i.e. phase and amplitude. Couplers, cabling, splitters, etc. used between these amplifiers and the columns can also vary in response. Thus, if a beamformer is placed before the amplifiers, the beamwidth is often not varied as selected by the beamformer due to variation in the response of the amplifiers, as well as other devices between the amplifiers and the columns.

One method of dealing with these variations is to do what is referred to as “calibrating” the antenna. One method involves the process of driving a first column of the antenna and simultaneously monitoring a second column to sample the radiation of the first column. This process of driving a first column and sampling a second column is typically repeated for each column until a calibration factor is determined for each column. Once calculated, the calibration factors for each column may then be added to any desired signal in the beamformer to properly form a beam during the normal operation of the antenna.

One shortcoming of this method is due to the variation of the radiating elements used in the second column to sample the radiation of the first column. Due to element variation in the second column, e.g., amplitude and phase, losses, etc., a calibration factor calculated for the first column may be affected by the variation of the radiating elements in the second column. Later, when the calibration factor for the first column is used for beamforming, the beam is not formed as accurately as it might have been had variation from the radiating elements from the second column not been introduced into the calibration for the first column. Another shortcoming of this method is that in order to perform the calibration, it may be necessary to reconfigure the cabling to the antenna. Another shortcoming is that this technique is affected by the external environment due to the fact that the signal is radiated by one column and received by another.

Therefore, a need exists for a manner of calibrating an antenna to be used in conjunction with a beamforming system that is easy to use, relatively simple in design and that can be manufactured at a relatively low cost.

### BRIEF DESCRIPTION OF THE DRAWINGS

The invention and further objectives and advantages thereof may best be understood by reference to the following description taken in conjunction with the accompanying drawings, in which:

FIG. 1 is a perspective view of an antenna incorporating an integrated calibration feed consistent with the present invention, with a portion thereof shown in phantom.

FIG. 2 is a cross section of the substrate of a portion of the antenna shown in FIG. 1, taken along lines 2-2.

FIG. 3 is an illustration of the inner conductive layer of a portion of the antenna shown in FIGS. 1 and 2, with repetitive portions shown in phantom, and showing the relative location of the dual polarized radiators relative thereto.

FIG. 4 is an enlarged perspective view of a dual polarized radiator shown in FIGS. 1 and 3.

FIG. 5 is an enlarged perspective view of a dual polarized radiator mounting area shown in FIGS. 1 and 3.

FIG. 6 is a schematic diagram of another antenna consistent with the present invention.

FIG. 7 is a flow chart illustrating the steps of a receive calibration process using the antenna of FIG. 6.

FIG. 8 is a flow chart illustrating the steps of a transmit calibration process using the antenna of FIG. 6.

### DETAILED DESCRIPTION OF THE DRAWINGS

The present invention provides an integrated aperture and calibration feed for adaptive beamforming systems that is easy to use, relatively simple in design and that can be manufactured at a relatively low cost. Such an integrated aperture and calibration feed often eliminates the use of a second column in calibrating a first column in an antenna, thereby providing a manner of calibrating the first column independent any variation in the radiating elements of a second column. Furthermore, in many embodiments the integrated aperture and calibration feed may facilitate improved beamforming without requiring any cable reconfiguration or errors due to external environment.

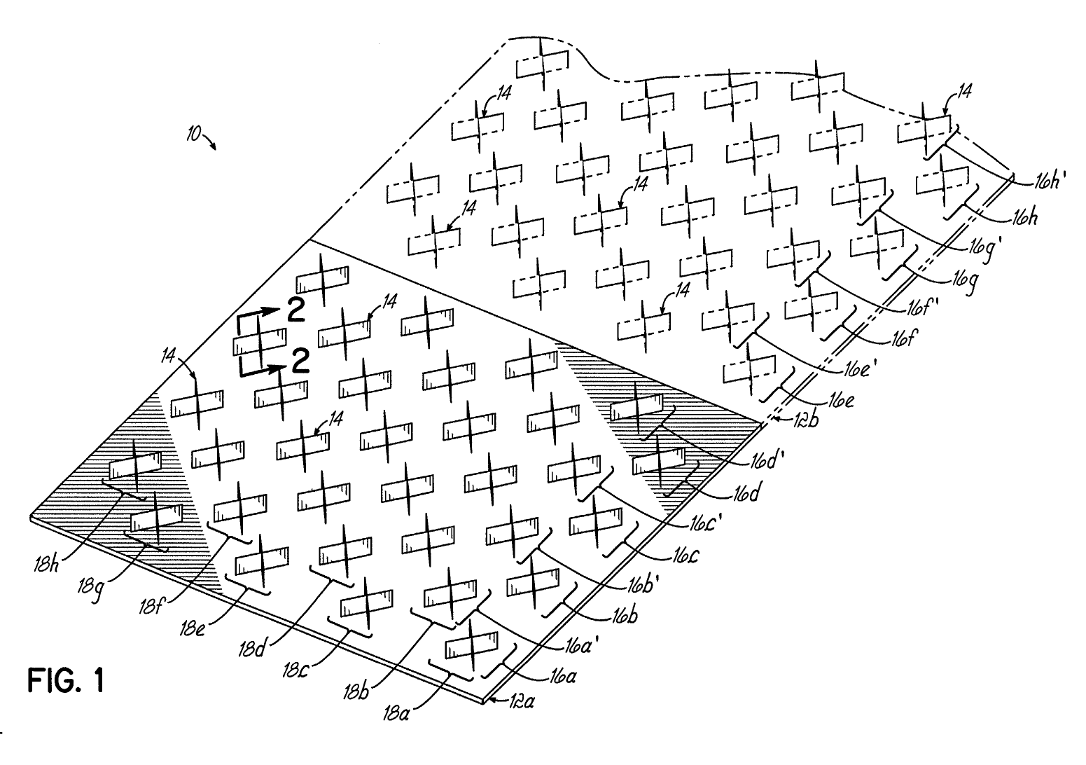

With reference to FIGS. 1-5, there is shown one embodiment 10 of an antenna in accordance with the principles of the present invention. Antenna 10 comprises a substrate, divided into two sections at reference numerals 12a, 12b, and a plurality of dual polarized radiators 14 coupled to the substrate 12a, 12b. Antenna 10 is approximately two feet wide and four feet high. The substrate can be a single piece, or may be formed from multiple sections as is shown in FIG. 1. Although antenna 10 is constructed using a divided substrate, antennas using a unitary, or one piece, substrate may be constructed without departing from the spirit of the present invention.

Dual polarized radiators 14 are arranged into a plurality of rows 16a-h, 16a′-16h′ and columns 18a-h. Dual polarized radiators 14 in rows 16a-h in columns 18a, 18c, 18e, 18g are offset with respect to the dual polarized radiators in rows 16a′-h′ in columns 18b, 18d, 18f, 18h, so as to equally space the dual polarized radiators 14 diagonally. The offset and accompanying equal spacing reduces the mutual coupling between adjacent dual polarized radiators 14 in adjacent columns 18a-h, improving performance and cross-polarization isolation. Other relative spacings of radiators may be used in the alternative.

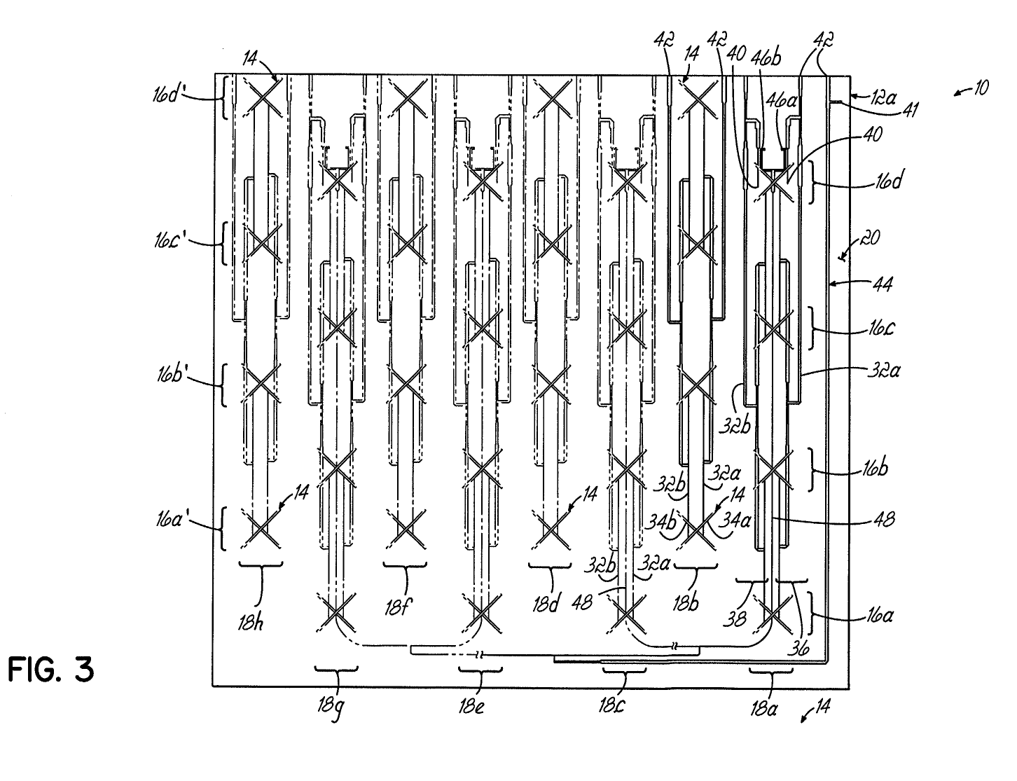

Since each portion 12a, 12b contains an equal number and like spacing of the radiators 14, and like feed networks, as will be shown in FIG. 3, the details of substrate 12b are not shown. One skilled in the art will readily appreciate that substrate 12b may be configured to function like substrate 12a, or may be differently configured in some applications.

Although the embodiment 10 of FIGS. 1-5 contains eight columns and eight rows, and each column 18a-h and each row 16a,a′-16h-h′ contains eight radiators 14, other embodiments of the invention may be constructed using any number of columns or rows containing any number of radiators. Further, while the embodiment of FIGS. 1-5 uses dual polarized dipole radiators with a common phase center to realize dual slant forty-five degree (45°) polarization with close column spacing, those skilled in the art will recognize that other embodiments of the present invention may be configured with other radiating elements, such as vertically or horizontally oriented dipoles, etc.

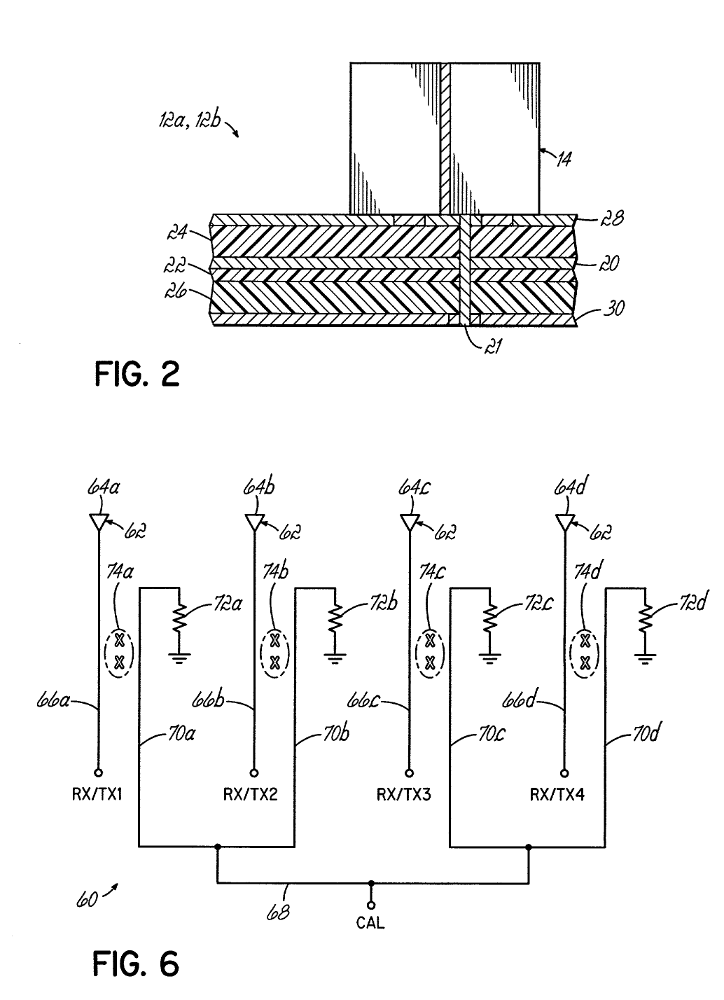

Referring now to FIG. 2, a cross section of a portion of the substrate 12a, 12b shown in FIG. 1 is illustrated. Substrate 12a, 12b comprises an inner layer 20 etched or deposited on a dielectric material 22 located between upper and lower sheets of dielectric material 24, 26, the outer surfaces of which have upper and lower ground planes 28, 30 etched or deposited thereon. Inner layer 20 may be about one once (1 oz.) finished copper. Dielectric material 22 may be about 0.004″ thick Rogers material. Dielectric materials 24, 26 may be about 0.032″ thick Rogers material. Ground planes 28, 30 may be about two ounce (2 oz.) finished copper, making substrate 12a, 12b about 0.068″ plus or minus (+/−) 0.005″ thick when assembled. As is common practice in the art, vias 21 may be used to connect the inner layer 20 to conductive materials in the upper and lower ground planes 28, 30, e.g., to provide an external connection point and/or to interface with a radiator 14 (as will be described below). Those skilled in the art will appreciate that the forgoing is merely exemplary of the possible materials, layouts, manufacturing processes, etc. that could be used for substrate 12a, 12b. As such, the present invention is not intended to be limited in the type of substrate used for various embodiments.

Referring to FIG. 3, inner layer 20 of substrate portion 12a of antenna 10 shown in FIGS. 1 and 2 is illustrated in greater detail. Columns 18a, 18b including rows 16a-d and 16a′-d′, respectively, are shown for purposes of illustration, whereas columns 18c-h are shown in phantom line due to redundancy. The locations of the radiators 14 are also shown in phantom line. Further, only substrate portion 12a is illustrated, as substrate portion 12b essentially mirrors substrate portion 12a, as will be discussed.

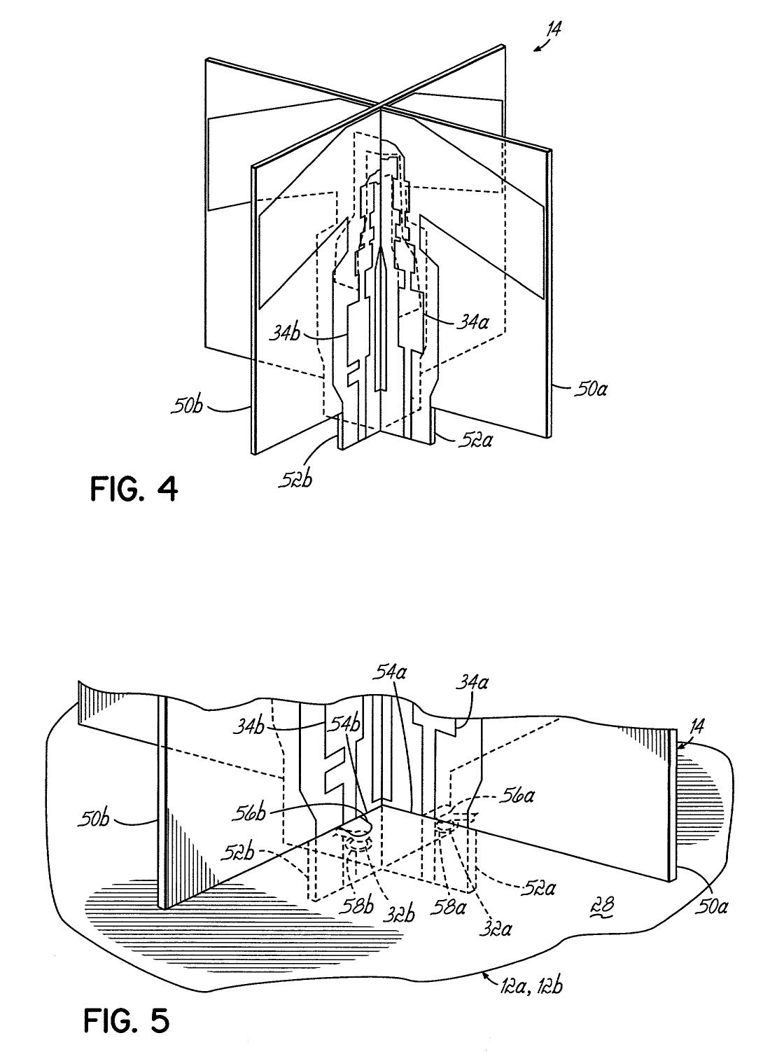

For each column 18a-h of substrate 12a, 12b, a pair of stripline distribution, or corporate feed, networks 32a, 32b are disposed in inner layer 20 and coupled to dual polarized radiators 14. Moreover, for each column, networks 32a and 32b are routed on opposite sides of the column. For column 18a, for example, corporate feed 32a is coupled to the first radiating elements 34a and corporate feed 32b is coupled to the second radiating elements 34b (shown in FIGS. 4 and 5) of the dual polarized radiators 14. Corporate feed network 32a extends along a first side 36 of column 18a, and corporate feed network 32b extends along a second side 38 of column 18a.

The portions of the corporate feed networks 32a, 32b on substrate portions 12a and 12b are connected together at reference numeral 42. At locations 42, a portion of upper and lower dielectric 24, 26 is relieved so that portions of the corporate feed networks 32a, 32b on substrates 12a, 12b may be soldered together.

Electrical connectivity with the corporate feed networks 32a, 32b may be provided through connectors located at reference numeral 40. As illustrated, connectors at locations 40 for columns 18a, 18c, 18e, 18g are on substrate 12a while the connectors 40 for columns 18b, 18d, 18f, 18h are on substrate 12b.

Substrate portions 12a, 12b also include a stripline calibration feed network 44. Stripline calibration feed network 44 includes calibration feed traces 48 that extend along the columns 18a-h of dual polarized radiators 14 intermediate the first and second corporate feed networks 32a, 32b, terminating in couplers 46a and 46b. As illustrated, the calibration feed traces 48 are aligned with the common phase centers of the dual polarized dipole radiators 14, realizing dual slant forty-five degree (45°) polarization. Couplers 46a, 46b for columns 18a, 18c, 18e, 18g and their feed traces 48 are disposed on substrate portion 12a while couplers 46a, 46b and their feed traces 48 for columns 18b, 18d, 18f, 18h are disposed on substrate portion 12b. Stripline calibration feed network 44 also includes a location 42 for soldering portions of the stripline calibration feed network on substrate portions 12a, 12b together. A connector location 41 is also advantageously provided for the stripline calibration feed network 44 on substrate 12a. Those skilled in the art will appreciate that other connector locations are possible without departing from the spirit of the present invention.

The calibration feed traces 48 and couplers 46a, 46b alternate between columns 18a, 18c, 18e, 18g on substrate portion 12a and columns 18b, 18d, 18f, 18h on substrate portion 12b so that mutual coupling between adjacent columns 18a-h and the calibration feed network 44 is reduced. The calibration feed network 44 includes portions proximate the ends of each column where the calibration feed traces are joined to connector location 41. For example, as illustrated in FIG. 3, for substrate portion 12a, columns 18a and 18c and columns 18e and 18g are joined together. The junctions of columns 18a and 18c and columns 18e and 18g are then joined together and connected to connector location 41. Substrate 12b includes a similar arrangement at the other end of the columns 18a-h for columns 18b, 18d, 18f, 18h, respectively.

Those skilled in the art will appreciate that calibration feed network 44, calibration feed traces 48 and couplers 46a, 46b could be located elsewhere on substrate portions 12a and 12b without departing from the spirit of the present invention. Such a calibration feed network 44, calibration feed traces 48 and couplers 46a, 46b could be located on the inner layer 20 of either substrate portion 12a or 12b solely, without departing from the spirit of the present invention. Further, such a calibration feed network 44 could also be located in another layer of substrate 12a, 12b without departing from the spirit of the present invention. However, such a configuration of substrate 12a, 12b may increase costs.

Couplers 46a, 46b are formed by adjacent portions of the corporate feed networks 32a, 32b and the end of feed traces 48, the end most portions being configured as loads. Such a physical arrangement on inner layer 20, as indicated at 46a and 46b, allows bidirectional coupling of an electrical signal between the corporate feed networks 32a, 32b and the distribution network 48. Those skilled in the art will appreciate that other types of proximity couplers, with or without loading, may be used without departing form the spirit of the present invention.

Referring to FIG. 4, an enlarged view of a dual polarized radiator 14 is shown. Dual polarized radiator 14 comprises a first radiating element 34a and a second radiating element 34b. Radiating elements 34a, 34b are deposited or etched on dielectric material 50a, 50b, as is well known in the art. Dielectric material 50a, 50b include a tab portion 52a, 52b for mounted the dual polarized radiator to substrate portions 12a, 12b.

Referring to FIG. 5, an enlarged view of a dual polarized radiator 14 mounting area is illustrated. Dual polarized radiator 14 is mounted to a substrate portion 12a, 12b by inserting tabs 52a, 52b into corresponding slots 54a, 54b in substrate 12a, 12b and soldering the radiating elements 34a, 34b to lands 56a, 56b etched out of the ground plane 28. Connection of the radiating elements 34a, 34b to corporate feed networks 32a, 32b on inner layer 20 may be made through vias 58a, 58b, respectively.

In operation, to calibrate the antenna 10 for transmission, a signal at a desired transmission frequency is applied to each connector location 40 for each of the columns 18a-h. The signal may be applied to the columns 18a-h sequentially or simultaneously, e.g., if a code division multiple access (CDMA) code may be used for each column 18a-h. The signal, in each column 18a-h, couples through locations 46 to calibration feed traces 48 in the stripline calibration feed network 44. The coupled signal may then be measured at connector location 41 for the stripline calibration feed network 44 and a calibration factor calculated for each column 18a-h, so that the radiation for each column 18a-h is equal after application of the calibration factor. A beamformer used with the antenna 10 may then multiply the signal for each column by the column transmit calibration factor to properly form a transmit beam, independent an adjacent column's radiators.

Similarly, to calibrate the antenna 10 for reception, a signal at a desired reception frequency is applied to connector location 41 of the stripline calibration feed network 48. The applied signal travels down the calibration feed traces 48 and couples through locations 46 to distribution feed networks 32a, 32b and connector locations 40 for columns 18a-h. The signal at columns 18a-h may then be measured and a calibration factor calculated for each column 18a-h, so that the signal from each column 18a-h is equal. A beamformer used with the antenna 10 may then multiply the signal received by each column by the column receive calibration factor to properly form a receive beam, independent an adjacent column's radiators.

Referring to FIG. 6, and for the purposes of further illustrating a calibration method consistent with the invention, a schematic diagram of an antenna 60 is illustrated. Antenna 60 comprises a plurality of radiators 62 arranged into a plurality of columns 64a-d, corresponding to receive/transmit (RX/TX) columns 1 through 4. Each column 64a-d includes a distribution network 66a-d. Antenna 60 further comprises a calibration feed network 68 having a calibration port (CAL) and including calibration feed traces 70a-d, each terminated in a load 72a-d. Mutual coupling occurs between calibration feed traces 70a-d and distribution networks 66a-d in areas 74a-d, respectively.

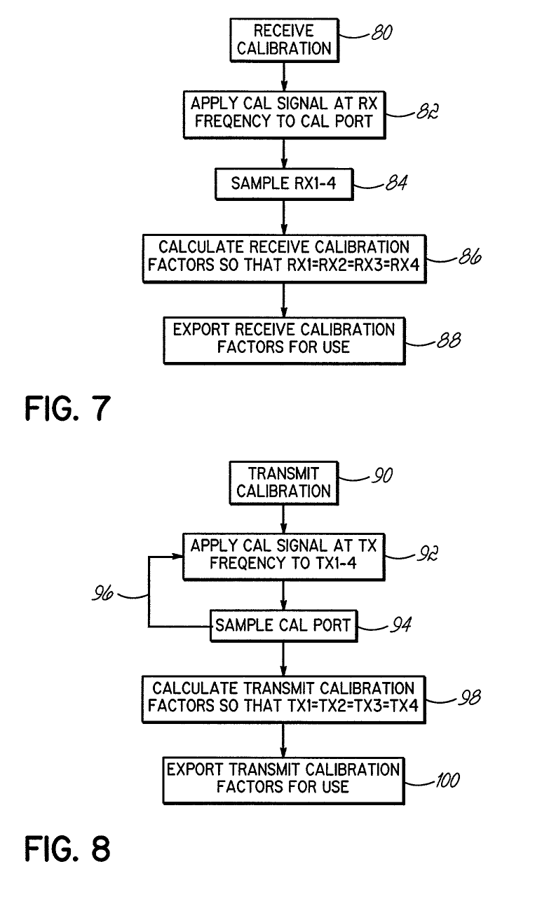

Referring now to FIGS. 6 and 7, FIG. 7 is a flow chart of a receive calibration routine 80 for the antenna 60 of FIG. 6. In order to calibrate the four reception paths, denoted as RX1-4, a calibration signal, at a desired reception frequency, is applied to the calibration port (CAL) at step 82.

The calibration signal traverses the calibration feed network 44 and the calibration feed traces 48a-d coupling through areas 46a-d into reception paths RX1-4. The coupled signal is then sampled for each path, or column 18a-h, at step 84.

In step 86, a receive calibration factor for each path is calculated so that RX1=RX2=RX3=RX4. The receive calibration factors for RX1-4 calibration are then exported for use, such as by a beamformer, in step 88.

Referring now to FIGS. 6 and 8, FIG. 8 is a flow chart of a transmit calibration routine 90 for the antenna 60 of FIG. 6. At step 92, a calibration signal, at a desired transmit frequency, is applied to TX1 and sampled at the calibration port (CAL) in step 94. This process is repeated for TX2-4, as shown at 96, until a sample is made for each transmit path, TX1-4. Once a sample is made for each transmit path, a transmit calibration factor for each path is calculated so that TX1=TX2=TX3=TX4 at step 98. The transmit calibration factors for TX1-4 are then exported for use, such as by a beamformer, in step 100.

By virtue of the foregoing, there is thus provided a integrated aperture and calibration feed for a beamforming system for use in varying the beamwidth of an antenna that is easy to use, relatively simple in design and that can be manufactured at a relatively low cost.

Various other modifications may be made to the herein-described embodiments without departing from the spirit and scope of the invention. For example, it will be appreciated that a wide variety of alternate antenna arrangements, including various alternate electronic components, layouts and the like, may be used consistent with the invention. Alternate routings of traces and/or positioning of connectors, e.g., at one end of the substrate or columns, etc., also may be used without departing from the spirit of the present invention. Therefore, the invention lies in the claims hereinafter appended.

What is claimed is:

1. An antenna, comprising:
(a) a substrate;
(b) a plurality of dual polarized radiators coupled to the substrate and arranged into a plurality of rows and columns, each dual polarized radiator including first and second radiating elements;
(c) a stripline distribution network disposed on the substrate and coupled to the plurality of dual polarized radiators, the stripline distribution network including first and second corporate feed networks coupled to a first column of dual polarized radiators among the plurality of columns, the first corporate feed network coupled to the first radiating elements of the dual polarized radiators in the first column and extending along a first side of the first column, and the second corporate feed network coupled to the second radiating elements of the dual polarized radiators in the first column and extending generally along a second side of the first column; and
(d) a stripline calibration feed network disposed on the substrate and coupled to the first and second corporate feed networks, the stripline calibration feed network including a calibration feed trace that extends along the first column of dual polarized radiators intermediate the first and second corporate feed networks.

2. The antenna of claim 1, wherein the dual polarized radiators are configured to realize dual slant forty-five degree (45°) polarization.

3. The antenna of claim 1, wherein the plurality of dual polarized radiators in adjacent columns are offset so that the radiators are diagonally equally spaced.

4. The antenna of claim 1, wherein the dual polarized radiators each comprise a pair of dipole elements.

5. The antenna of claim 2, wherein the wherein the dual polarized radiators are configured with a common phase center.

6. The antenna of claim 5, wherein the calibration feed trace is aligned with the common phase centers of the dual polarized radiators in the first column.

7. The antenna of claim 1, wherein the calibration feed trace terminates in a pair of couplers, the couplers coupling the first and second corporate feed networks with the stripline calibration network.

8. The antenna of claim 7, wherein the end most portion of the calibration feed trace includes a load.

9. The antenna of claim 1, wherein the stripline calibration feed network includes a calibration feed trace for each column of dual polarized radiators, and wherein calibration feed traces for all of the columns of dual polarized radiators are joined at a common connection point.

10. The antenna of claim 9, wherein the calibration feed traces for adjacent columns of dual polarized radiators extend along the columns from opposite ends of the columns.

11. A substrate for an antenna of the type including a plurality of dual polarized radiators arranged into a plurality of rows and columns, each dual polarized radiator including first and second radiating elements, the substrate comprising:
(a) a stripline distribution network having connections for the plurality of dual polarized radiators, the stripline distribution network including first and second corporate feed networks for coupling to a first column of dual polarized radiators among the plurality of columns, the first corporate feed network for coupling to the first radiating elements of the dual polarized radiators in the first column and extending along a first side of the first column, and the second corporate feed network for coupling to the second radiating elements of the dual polarized radiators in the first column and extending generally along a second side of the first column; and,
(b) a stripline calibration feed network disposed on the substrate and coupled to the first and second corporate feed networks, the stripline calibration feed network including a calibration feed trace that extends along the first column of dual polarized radiators intermediate the first and second corporate feed networks.

12. The substrate of claim 11, wherein the dual polarized radiators are configured to realize dual slant forty-five degree (45°) polarization.

13. The substrate of claim 11, wherein the dual polarized radiators in adjacent columns are offset so that the radiators are diagonally equally spaced.

14. The substrate of claim 11, wherein the dual polarized radiators each comprise a pair of dipole elements.

15. The substrate of claim 11, wherein the dual polarized radiators are configured with a common phase center.

16. The substrate of claim 15, wherein the calibration feed trace is aligned with the common phase centers of the dual polarized radiators in the first column.

17. The substrate of claim 11, wherein the calibration feed trace terminates in a pair of couplers, the couplers coupling the first and second corporate feed networks with the stripline calibration network.

18. The substrate of claim 17, wherein the end most portion of the calibration feed trace includes a load.

19. The substrate of claim 11, wherein the stripline calibration feed network includes a calibration feed trace for each column of dual polarized radiators, and wherein the calibration feed traces for all of the columns of dual polarized radiators are joined at a common connection point.

20. The substrate of claim 19, wherein the calibration feed traces for adjacent columns of dual polarized radiators extend along the columns from opposite ends of the columns.

21. A method of calibrating an antenna, wherein the antenna comprises a substrate and a plurality of dual polarized radiators coupled to the substrate and arranged into a plurality of rows and columns, each dual polarized radiator including first and second radiating elements, the method comprising:
(a) applying a first signal to at least one of a stripline calibration feed network and a stripline distribution network disposed on the substrate wherein
(i) the stripline distribution network is disposed on the substrate and coupled to a plurality of dual polarized radiators, the stripline distribution network including first and second corporate feed networks coupled to a first column of dual polarized radiators among a plurality of columns, the first corporate feed network coupled to the first radiating elements of the dual polarized radiators in the first column and extending along a first side of the first column, and the second corporate feed network coupled to the second radiating elements of the dual polarized radiators in the first column and extending generally along a second side of the first column; and,
(ii) the stripline calibration feed network is also disposed on the substrate and coupled to the first and second corporate feed networks, the stripline calibration feed network including a calibration feed trace that extends along the first column of dual polarized radiators intermediate the first and second corporate feed networks;
(b) in response to applying the first signal, sampling a second signal from the other of the stripline calibration feed network and the stripline distribution network; and
(c) calculating at least one calibration factor from the second signal.

22. The method of claim 21, wherein the stripline distribution network includes a plurality of portions, each portion coupled to the dual polarized radiators in one of the plurality of columns.

23. The method of claim 22, wherein the first signal is applied to the plurality of portions of the stripline distribution network sequentially.

24. The method of claim 22, wherein the first signal is applied to the plurality of portions of the stripline distribution network simultaneously.

25. The method of claim 22, wherein the first signal is a code division multiple access signal having a code associated with each column.
